(19) United States
(12) Patent Application Publication
(10) Pub. No.: US 2010/0132860 A1
(43) Pub. Date: Jun. 3, 2010

(54) TIRE CONTAINING CLOSED CELLULAR RUBBER FOAM IN ITS TIRE CAVITY WHICH CONTAINS DIVERSE CARBON BLACKS

(76) Inventors: Paul Harry Sandstrom, Cuyahoga Falls, OH (US); George Frank Balogh, North Canton, OH (US); Leighton Randolph Spadone, Beachwood, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/327,120

(22) Filed: Dec. 3, 2008

(51) Int. Cl. B60B 19/00; C08K 3/04; B60C 5/00

(52) U.S. Cl. 152/155; 524/495

(57) ABSTRACT

Field of Invention The present invention relates to a pneumatic tire having its internal cavity containing a closed cellular rubber which contains a dispersion of at least two diverse carbon blacks to promote an improved path for thermal conductivity with suitable physical properties for the closed cellular foam rubber.

### FIELD OF INVENTION

The present invention relates to a pneumatic tire having its internal cavity containing a closed cellular rubber with a dispersion of at least two diverse carbon blacks to promote an improved path for thermal conductivity.

### BACKGROUND OF THE INVENTION

Tires having their cavities filled with closed cellular rubber foam are useful in a sense of being substantially deflation proof for various applications, particularly where it is desired to maintain associated vehicles in service for extended periods without loss of vehicular time.

Exemplary of various filled tires are, for example, U.S. Pat. Nos. 3,022,810, 3,381,735, 3,650,865, 3,872,201, 4,060,578, 4,060,578 and 6,623,580.

However, the closed cellular rubber is typically inherently resistive to thermal conductivity because of the thermally insulative nature of its closed cellular structure.

For this invention it is desired to promote thermal conductivity for the closed cellular rubber.

It is particularly desired to provide a pneumatic tire in which its internal cavity contains a thermal conductivity enhanced closed cellular rubber, particularly where said closed cellular rubber is derived from a thermal conductivity enhanced solid rubber precursor for the closed cellular rubber.

While it might be envisioned that its thermal conductivity might be increased by simply increasing the content of carbon black reinforcement in the rubber, such increase in its carbon black reinforcement would be expected to make the rubber more hysteretic to thereby cause a more rapid internal heat build up within the rubber during use which is an unwanted effect where promotion of its thermal conductivity is desired.

A challenge is presented of promoting an increase in its thermal conductivity.

The challenge is divided into two parts, or aspects.

A first desirable aspect is to provide improved thermal conductivity, and an associated path of thermal conductivity, for the closed cellular rubber within the tire cavity. The purpose is to promote dissipation of internally generated heat (heat generated by the use of the tire under service conditions) from the closed cellular rubber to the tire casing and thereby provide a beneficially cooler running tire.

A second desirable aspect is to provide improved thermal conductivity, and an associated path of thermal conductivity, for the solid rubber precursor of the closed cellular rubber within the tire cavity. The purpose is to promote more efficient heating (more rapid heating and thereby more rapid temperature increase) of the cellular rubber precursor within the tire cavity (by application of heat to the tire casing) to thereby more efficiently activate (elevated temperature activation) the blowing agent in the rubber based precursor to form the closed cellular rubber and, further, to promote a more efficient curing of the closed cellular rubber within the tire cavity. In addition, a reduction in heat history for the already cured tire carcass is also beneficially promoted.

For this invention, the thermal conductivity is provided by use of a combination of diverse carbon blacks in a sense of increasing the carbon black content without significantly increasing the carbon black reinforcement by using low rubber reinforcing carbon blacks, particularly thermally conductive carbon blacks, or a combination of low rubber reinforcing carbon black with thermally conductive carbon black.

In practice, closed cellular rubber foam contained within its tire cavity may be prepared, for example, by inserting strips of foamable rubber (closed cellular foam rubber precursor) into a pre-shaped and cured rubber tire cavity which is then mounted on a metal tire rim to form a wheel assembly thereof. The rubber composition for the foam rubber precursor contains a curative and heat activatable (elevated temperature activatable) blowing agent. Upon heating the assembly the foam rubber precursor expands and cures to form a closed cellular structure to fill the tire cavity and form a cellular foam/tire casing assembly.

Alternately, the cellular foam can be removed and inserted into to another tire casing.

In this manner, the cured rubber tire casing is submitted to an additional heat history beyond its prior shaping and curing under conditions of elevated temperature and pressure.

The aforesaid challenge is to provide an improvement in the methodology of manufacturing the foam filled rubber tire by promoting a more rapid temperature increase, to result in both an associated shorter closed cellular formation time and rubber curing time within the tire cavity.

The innovation to meet such challenge is provided by promoting a path of thermal conductivity by an inclusion within the foam rubber precursor and within the resultant closed cellular structure a dispersion of a combination of at least two diverse carbon blacks in one sense of having diverse surface areas (nitrogen absorption values) and diverse structures (dibutylphthalate absorption values) and in an additional sense of utilization of thermally conductive carbon blacks which are not considered as being conventional rubber reinforcing carbon blacks.

In the description of this invention, the term “phr” is used to designate parts by weight of an ingredient per 100 parts of elastomer unless otherwise indicated. The terms “elastomer” and “rubber” may be used interchangeably unless otherwise indicated. The terms “cure” and “vulcanize” may be used interchangeably unless otherwise indicated.

### SUMMARY AND PRACTICE OF THE INVENTION

In accordance with this invention, a pneumatic rubber tire is provided with its internal cavity containing, and preferably filled, or at least substantially filled, with a closed cellular rubber wherein the rubber composition of said closed cellular rubber contains a dispersion of at least two diverse carbon blacks to promote a path of thermal conductivity;

wherein said rubber is comprised of at least one conjugated diene-based elastomer and contains from about 20 to about 60 phr of at least two diverse carbon blacks;

wherein said diverse carbon blacks are selected from at least two carbon blacks comprised of:

(A) about 5 to about 30 phr of Category A rubber reinforcing carbon black having a nitrogen adsorption surface area (NSA) in a range of from about 30 to about 60 m²/g together with a DBP adsorption value in a range of from about 70 to about 140 cc/100 g (thus a carbon black with a relatively large particle size as indicated by its relatively low NSA absorption value—and medium to high structure as indicated by its relatively medium to high DBP absorption value), and

(B) about 5 to about 40 phr of carbon black comprised of at least one of:
(1) Category B low rubber reinforcing carbon black having a nitrogen adsorption surface area (NSA) in a range of from about 3 to about 30 m²/g together with a DBP adsorption value in a range of from about 20 to about 50 cc/100 g (thus a carbon black with a relatively large particle size as indicated by its relatively low NSA absorption value and relatively low structure as indicated by its relatively low DBP absorption value),
(2) Category C thermally conducting carbon black having a nitrogen adsorption surface area (NSA) in a range of from about 50 to about 75 m²/g, and
(3) Category D thermally conductive carbon black having a nitrogen adsorption surface area (NSA) in a range of from about 80 to about 120 m²/g together with a DBP adsorption value in a range of from about 190 to about 210 cc/100 g (thus a carbon black having a relatively small particle size as indicated by its relatively large NSA absorption value and a high structure as indicated by its DBP absorption value).

In a further practice of this invention a tire assembly is provided which is comprised of a pneumatic cured rubber tire with its internal cavity containing a plurality of layers of solid uncured rubber composition to form an assembly of said cured tire and uncured rubber composition, wherein said uncured rubber composition contains a dispersion of at least two of said diverse carbon blacks to promote a path of thermal conductivity;

wherein said uncured rubber composition is comprised of at least of at least one conjugated diene-based elastomer and contains from about 20 to about 60 phr of at least two of said diverse carbon blacks and a temperature activatable blowing agent.

In additional practice of this invention, a tire is provided wherein said tire assembly of cured tire and uncured rubber composition is heated to activate said temperature activatable blowing agent to form a cellular rubber from said uncured rubber composition, and to cure said closed cellular rubber, to thereby form a pneumatic tire containing a cellular rubber within its tire cavity.

Representative of Category (A) carbon blacks are rubber reinforcing carbon blacks such as, for example, N660, N650, N550 and N539, which are ASTM designations.

Representative of Category (B) carbon black is, for example, Regal 85™ carbon black from the Cabot Corporation having a NSA value of, for example, about 25 m²/g and a DBP value of, for example, about 30 cc/100 g.

Representative of Category (C) thermally conductive carbon blacks are, for example, Pureblack™ 205 and Pureblack™ SCD-550 having NSA values of 50 and 73 m²/g, respectively, from Columbian Chemicals which are marketed as and considered herein as being thermally conductive carbon blacks.

Representative of Category (D) carbon black is, for example, an acetylene derived carbon black such as “acetylene carbon black” from Chevron Chemical Company reportedly having a NSA value of about 102 m²/g and a DBP value of about 202 cc/100 g.

Further representative thermally conductive carbon blacks are, for example, Raven 2000, Raven 5000 and Raven 7000 carbon blacks from the Columbian Carbon Company reportedly having DBP values in a range of from about 65 to about 178 cc/100 g and NSA values in a range of from about 194 to about 613 m²/g. These carbon blacks may also be suitable for use as thermally conductive carbon blacks for this invention.

Carbon black properties such as DBP (dibutyl phthalate) absorption values, Iodine absorption values and nitrogen surface area (NSA) nitrogen absorption values are well known to those having skill in such art.

For example, the nitrogen surface area (NSA) values (e.g. ASTM D3037) and Iodine absorption values for carbon black are normally considered to be a measure of its surface area and is expressed in units of square meters/gram (m²/g). A higher NSA surface value is indicative of smaller particle size for the carbon black which may promote higher reinforcement for elastomers.

For example, the DBP (dibutylphthalate) values for carbon black is normally considered to be a measure of its structure, or aggregate size and is expressed in cubic centimeters per 100 grams of carbon black. A higher DBP adsorption number is indicative of larger aggregates which, in turn, is indicative of higher structure for the carbon black.

Various rubber reinforcing carbon blacks, (generally recognized as being rubber reinforcing carbon blacks) together with associated ASTM designated N—numbers may be found, for example, in The Vanderbilt Rubber Handbook, Thirteenth Edition (1990), Page 417.

A significant aspect of the required inclusion of the dispersion of the said Category A rubber reinforcing carbon black is to provide rubber reinforcement for the cellular rubber foam.

A significant aspect of the inclusion of the dispersion of the said Category B low rubber reinforcing carbon black is to enable an increase of carbon black content of the rubber to promote an increase in thermal conductivity of the cellular rubber composition through increased carbon black content with minimal, or minor if any, effect upon rubber reinforcement and thereby only a minimal or minor if any, increase in the rubber hysteresis (with resultant minor, if any increase in internal heat generation within the cellular rubber composition).

A significant aspect of the inclusion of the dispersion of the said Category C and D thermally conductive carbon black(s) is to promote thermal conductivity of both the closed cellular rubber foam precursor (the solid rubber) and the resultant closed cellular rubber by using an inclusion of a small amount of such carbon black in the rubber composition and, because of the use of the small amount, only a minimal or minor if any, increase in the rubber hysteresis is expected (with a resultant minor, if any, increase, in internal heat generation within the cellular rubber composition).

The effect of inclusion of the aforesaid combination of diverse carbon blacks composed of the said rubber reinforcing carbon black Category A together and in combination with at least one of said additional Category B low rubber reinforcing carbon black or Category C or D highly thermally conductive carbon black is considered herein as being a novel approach to provide enhanced thermal conductivity of the cellular rubber without a significant penalty of increasing its hysteresis.

In further accordance with this invention, a wheel assembly is provided which is comprised of:

(A) a cylindrical metal tire rim, and

(B) the said tire fitted onto said rim with its internal cavity containing said closed cellular rubber wherein the rubber composition of said closed cellular rubber contains said dispersion of at least two diverse carbon blacks.

In additional accordance with this invention, a wheel assembly is provided which is comprised of:

(A) a cylindrical metal tire rim, and

(B) the said tire fitted onto said rim with its internal cavity containing said plurality of layers of solid uncured rubber composition to form an assembly of said cured tire and uncured rubber composition, wherein said uncured rubber composition contains said dispersion of at least two of said diverse carbon blacks and a temperature activatable blowing agent.

The following Drawings are provided to further understand and illustrate the invention.

### BRIEF DESCRIPTION OF THE DRAWINGS

The accompanying Drawings include a cross-sectional view of a tire with portions cut away to illustrate a preparation of a tire, and associated wheel assembly, wherein said tire is comprised of a pneumatic tire having its cavity filled with a closed cellular rubber which contains a dispersion of diverse carbon blacks

### THE DRAWINGS

In the Drawings, a pneumatic tire (1) is provided having a tire cavity (2).

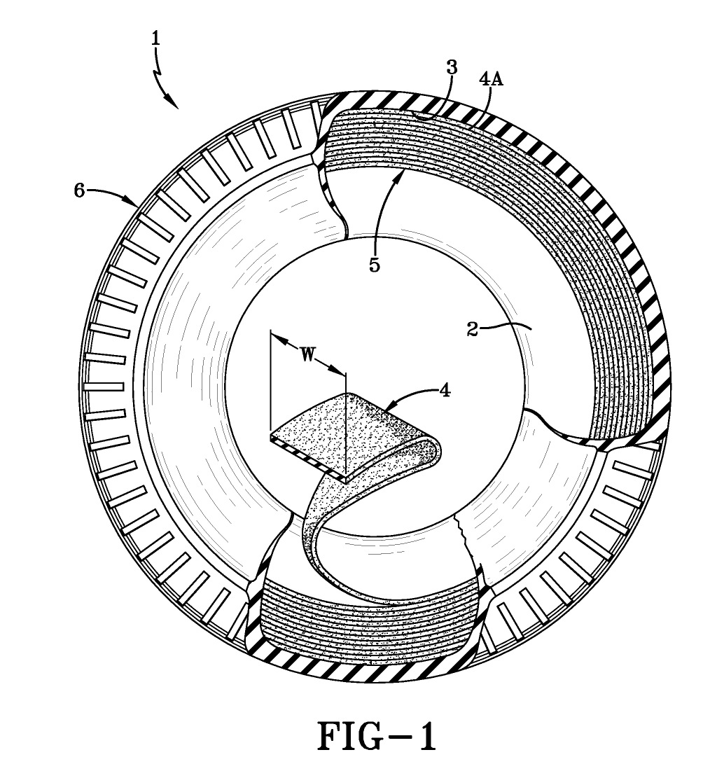

In FIG. 1, a first assembly (A) is formed by placing a plurality of uncured foamable rubber strips (4) in an annular fashion within the cured tire cavity (2) to partially fill the tire cavity (2). An adhesive has been applied to the surface of the tire cavity (2) for increasing the adhesion of the layers of the strips (4) against the tire cavity surface (5).

The uncured foamable rubber strips (closed cellular foam precursor) contain said dispersion of diverse carbon blacks which include a Category A rubber reinforcing carbon black for rubber reinforcement and at least one of Category B, C or D carbon blacks to provide enhanced thermal conductivity for the rubber cellular rubber precursor as well as the cellular rubber itself without incurring a significant increase in hysteretic penalty for the rubber composition.

Successive layers of the strips (4) are placed within the tire cavity to form a built-up uncured, foamable, rubber insert comprised of a plurality of the strips (4) in annular planes which are concentric and generally parallel to the annular plane of the tire tread (6). The width of the strips (4) somewhat approximates the width of the portion of the tire cavity (2) in which they are placed.

The successive layers of the strip (4) are generally substantially equal in thickness.

Alternately a continuous strip (4) of uncured, foamable rubber is spirally disposed within the tire cavity (2).

Alternately, for a relatively wide tire (1) the strips (4), or at least a portion of the strips (4), can be placed in a side-by-side relation within the tire cavity (2).

The quantity of foamable rubber composition for the strip (4) is somewhat related to its blowing agent content and a desired load bearing capability desired for the tire.

The tire (1) with the rubber strips (4) placed in the tire cavity (2) is mounted on a metal rim (not shown) to form an assembly thereof (not shown).

The assembly is placed in an autoclave and heated to an elevated temperature to cause the blowing agent to activate and cause the foamable rubber to expand to form a closed cellular foam within the tire and pressed against the metal rim.

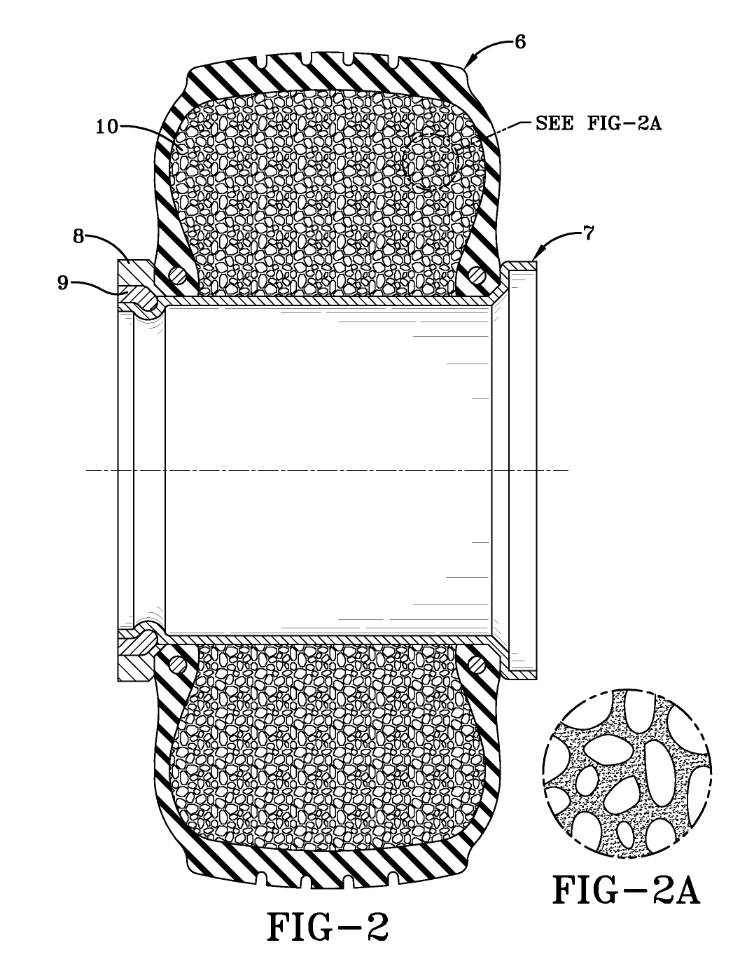

In FIG. 2, the assembly of the expanded closed cellular rubber foam (10) filled tire (1) mounted on the metal rim (7) is shown.

In FIG. 2A is shown an enlarged portion of the expanded closed cellular rubber foam (10) which depicts the plurality of cells surrounded by the rubber composition which contains the dispersed thermally conductive carbon black particles.

A path of thermal conductivity is formed by the dispersed diverse carbon blacks comprised of rubber reinforcing Category A carbon black together and in combination with at least one of said additional Category B low rubber reinforcing carbon black or Category C or D highly thermally conductive carbon black as a novel approach to provide enhanced thermal conductivity of the cellular rubber, as well as the solid rubber precursor, without a incurring a significant penalty of an increase in its hysteresis.

Such path of thermal conductivity for the foamable solid rubber composition within the tire cavity enables applied heat in the autoclave to more rapidly heat up (promotion of a more rapid temperature rise within the foamable rubber composition) to thereby more quickly activate the blowing agent, expand the rubber composition and to cure the closed cellular rubber structure within the tire cavity, all while conserving heat history applied to the already cured rubber tire casing.

Such path of thermal conductivity for closed cellular rubber structure within the tire cavity aids in dissipating internal heat buildup to promote a cooler running tire.

In this manner the heat history of the pre-formed cured rubber tire is minimized as compared to forming the closed cellular rubber foam within the tire cavity without the inclusion of the aforesaid combination of diverse carbon blacks.

Therefore, significant aspects of the invention include the above beneficial promoted effects for the preparation and the resultant closed cellular rubber foam filled rubber tire and particularly a tire/rim assembly and particular a vehicular wheel composed of such tire/rim assembly.

This is considered herein to be significant departure from and significantly novel in view of past foam filled tire practice.

Therefore, it is considered herein that a new, novel tire which contains a cellular foam rubber in its cavity with an inclusion of a thermally conductive carbon black is provided as such significant departure from past practice.

In practice, various blowing agents may be used for the formation of the cellular rubber which are compounds which liberate gases upon heating to an elevated temperature and cause the formation of the cellular rubber. Representative examples of various gases are, for example, nitrogen and carbon dioxide. For example ammonium bicarbonate and sodium bicarbonate can release carbon dioxide, although usually compounds which liberate nitrogen are preferred. Such blowing agents are compounds which liberate gases upon being triggered for their release by an elevated temperature at or near the vulcanization temperatures for the rubber itself, (temperature activated blowing agents), representative of which are, for example nitro, sulfonyl and azo compounds such as, for example, dinitrosopentamethylene tetramine, N,N′-dimethyl-N,N′-dinitrosophthalamide, azodicarbonamide, N,N′-dinitrosopentamethylene tetramine, sulfonyl hydrazides such as benzenesulfonyl hydrazide, toluene-sulfonyl hydrazide and p,p′-oxy-bis-(benzenesulfonyl)hydrazide and sulfonyl semicarbazides such as p-toluene sulfonyl semicarbazide, p,p′-oxy-bis-(benzenesulfonyl semicarbazide) and diphenyloxide-4,4′-disulphenyldrazide.

The following Example is provided to further illustrate the invention. Parts and percentages are by weight unless otherwise indicated.

### Example

Rubber compositions were prepared for evaluating an effect of an inclusion of dispersion of diverse carbon blacks in a closed cellular formable rubber composition for a closed cellular rubber tire cavity filling.

Sample A is a Control rubber sample which contains a conventional rubber reinforcing carbon black Category A.

Samples B through G are Experimental rubber Samples which contain Category B low reinforcing carbon black or Category C or D thermally conductive carbon black.

The rubber compositions were prepared by mixing the ingredients in sequential non-productive (NP) and productive (PR) mixing steps in one or more internal rubber mixers.

The basic recipe for the rubber Samples is presented in the following Table 1. A blowing agent can be added in the Productive mixing step to provide the cellular rubber foam.

TABLE 1

| | Parts |
|---|---|
| Non-Productive Mixing Step (NP), (mixed to 160° C.) | |
| Cis 1,4-polyisoprene rubber¹ | 100 |
| Category A rubber reinforcing carbon black (A)² | variable |
| Category B low rubber reinforcing carbon black (B)³ | variable |
| Category C thermally conductive carbon black (C)⁴ | variable |
| Category D thermally conductive carbon black (D)⁵ | variable |
| Medium rubber processing oil⁶ | 25 |
| Productive Mixing Step (P), (mixed to 110° C.) | |
| Sulfur⁷ | 3 |
| Zinc oxide | 5 |
| Organoperoxide curative⁸ | 7 |

¹Synthetic cis 1,4-polyisoprene rubber as Natsyn 2200 ™ from The Goodyear Tire & Rubber Company
²Rubber reinforcing carbon black as N660, an ASTM designation, having a DBP of about 90 cc/100 g, an NSA of about 35 m²/g
³Regal 85 ™ from Cabot Corporation, a carbon black having a DBP of about 30 cc/100 g and NSA of about 25
⁴Pureblack ™ SCD-205 from Columbian Chemicals, as a thermally conductive carbon black having an NSA of about 50 m²/g with an average particle size of about 42 nanometers (nm)
⁵Pureblack ™ SCD-550 from Columbian Chemicals, as a thermally conductive carbon black having an NSA of about 73 m²/g with an average particle size of about 32 nanometers (nm).
⁶Napex ™ from ExxonMobil
⁷Rubber Makers Sulfur
⁸Composite of dicumyl peroxide on calcium carbonate (45 weight percent dicumyl peroxide for the composite and thus considered as being 45 percent dicumyl peroxide active) and reported in the Table as the composite

Exemplary of a suitable blowing agent which may be added to the rubber composition in the Productive mixing step is, for example, a composite of diphenyloxide-4,4′-disulphenyldrazide (blowing agent) and a polymeric binder in a 75/25 weight ratio thereof as Akrosperse™ BBSH-75-EPR-S from Akrochem. The composite is therefore 75 percent active insofar as the blowing agent is concerned.

The following Table 2 illustrates cure behavior and various physical properties of rubber compositions based upon the basic recipe of Table 1.

TABLE 2

| | Samples | | | | | | |
|---|---|---|---|---|---|---|---|
| | Control | | | | | | |
| | A | B | C | D | E | F | G |
| Rubber reinforcing carbon black A (phr) | 20 | 0 | 15 | 0 | 0 | 0 | 0 |
| Low reinforcing carbon black B (phr) | 0 | 20 | 30 | 40 | 0 | 0 | 0 |
| Thermally conductive carbon black C (phr) | 0 | 0 | 0 | 0 | 40 | 0 | 0 |
| Thermally conductive carbon black D (phr) | 0 | 0 | 0 | 0 | 0 | 40 | 60 |
| Rheometer, MDR¹, 160° C., 30 min | | | | | | | |
| Maximum torque (dNm) | 6.0 | 5.3 | 7.6 | 6.6 | 9.6 | 9.5 | 13.5 |
| Minimum torque (dNm) | 1.2 | 1.1 | 1.3 | 1.3 | 2.1 | 2.1 | 3.6 |
| Delta torque (dNm) | 4.8 | 4.2 | 6.3 | 5.3 | 7.5 | 7.4 | 9.8 |
| T25 (minutes) | 11.4 | 9.8 | 11.8 | 11.3 | 11.3 | 11.5 | 21.1 |
| T90 (minutes) | 13.2 | 13.6 | 12.9 | 12.8 | 14.8 | 15.4 | 16.3 |
| Stress-strain, ATS, ring tensile, 14 min, 160° C.² | | | | | | | |
| Tensile strength (MPa) | 12.0 | 10.5 | 13.1 | 13.0 | 11.2 | 11.4 | 11.4 |
| Elongation at break (%) | 643 | 707 | 566 | 624 | 650 | 710 | 673 |
| 100% modulus (MPa) | 0.58 | 0.48 | 0.76 | 0.61 | 0.66 | 0.52 | 0.60 |
| 300% modulus (MPa) | 2.2 | 1.3 | 3.7 | 2.5 | 2.2 | 1.6 | 2.1 |
| Rebound | | | | | | | |
| 23° C. | 73 | 78 | 72 | 73 | 55 | 53 | 41 |
| 100° C. | 81 | 84 | 80 | 81 | 66 | 64 | 53 |
| Thermal conductivity³ (watts per meter) | 0.154 | 0.146 | 0.187 | 0.185 | 0.272 | 0.250 | 0.332 |

¹Data according to Moving Die Rheometer instrument, model MDR-2000 by Alpha Technologies, used for determining cure characteristics of elastomeric materials, such as for example Torque, T25, etc.
²Data according to Automated Testing System instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
³The thermal conductivity is a measure of heat transfer rate through a cured rubber composition. Thus, a higher value is indicative of faster rate of heat dissipation by the rubber composition. The test values are reported in terms of watts per meter (W/m) at a test temperature of 125° C.

From Table 2 it can be seen from Experimental rubber Sample D that use of higher levels of Category B low reinforcing can provide improved Thermal Conductivity (watts per meter) of the rubber composition with similar hysteresis property (rebound property) as the Control rubber Sample A.

From Table 2 it can be seen from Experimental rubber Sample C that use of a combination of Category A reinforcing carbon back and Category B low reinforcing carbon black can provide improved Thermal Conductivity (watts per meter) with similar rubber hysteretic properties (Rebound properties) as the Control rubber Sample A.

From Table 2 it can further be seen from Experimental rubber Samples E, F and G that addition of only small amounts of thermally conductive Category C and D carbon blacks provided a large increase of Thermal Conductivity (watts per meter) of the rubber composition which was, however, accompanied with a higher hysteresis property (Rebound property) as compared to the Control rubber Sample A. Therefore, to reduce the desired increase in Thermal Conductivity without a significant hysteresis penalty, it is considered herein that the thermally conductive carbon blacks C and D would be used at a much lower level when combined with carbon black A.

It is concluded from the experimental results shown in Table 2 that by using selected diversely different carbon blacks, improved thermal conductivity can be provided without a significant hysteresis penalty for the rubber composition.

In summary, it is considered herein that such experimental results justify a first approach of enhancing thermal conductivity of the rubber composition by use of a combination of diverse carbon blacks comprised of a rubber reinforcing Category A carbon black and a low rubber reinforcing Category B carbon black in as sense that a larger overall carbon black content can thereby be used for the rubber composition.

In summary, it is further considered herein that such experimental results justify a second approach of enhancing thermal conductivity of the rubber composition by use of a combination of diverse carbon blacks comprised of a rubber reinforcing Category A carbon black and a low level of a Category C or Category D thermally conductive carbon black in a sense of not requiring use of a significantly increased carbon black content for the rubber composition.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic rubber tire with its internal cavity containing a closed cellular rubber within its internal cavity wherein the rubber composition of said closed cellular rubber contains a dispersion of at least two diverse carbon blacks to promote a path of thermal conductivity;
wherein said rubber composition is comprised of at least one conjugated diene-based elastomer and contains from about 20 to about 60 phr of at least two diverse carbon blacks;
wherein said diverse carbon blacks are comprised of:
(A) about 5 to about 30 phr of Category A rubber reinforcing carbon black having a nitrogen adsorption surface area (NSA) in a range of from about 30 to about 60 m²/g together with a DBP adsorption value in a range of from about 70 to about 140 cc/100 g, and
(B) about 5 to about 40 phr of carbon black comprised of at least one of:
(1) Category B low rubber reinforcing carbon black having a nitrogen adsorption surface area (NSA) in a range of from about 3 to about 30 m²/g together with a DBP adsorption value in a range of from about 20 to about 50 cc/100 g,
(2) Category C thermally conducting carbon black having a nitrogen adsorption surface area (NSA) in a range of from about 50 to about 75 m²/g, and
(3) Category D thermally conductive carbon black having a nitrogen adsorption surface area (NSA) in a range of from about 80 to about 120 m²/g together with a DBP adsorption value in a range of from about 190 to about 210 cc/100 g.

2. A tire assembly comprised of a pneumatic cured rubber tire with its internal cavity containing a plurality of layers of solid uncured rubber composition to form an assembly of said cured tire and uncured rubber composition, wherein said uncured rubber composition contains a dispersion of at least two diverse carbon blacks to promote a path of thermal conductivity;
wherein said uncured rubber composition is comprised of at least one conjugated diene-based elastomer and contains from about 20 to about 60 phr of at least two diverse carbon blacks;
wherein said diverse carbon blacks are comprised of:
(A) about 5 to about 30 phr of Category A rubber reinforcing carbon black having a nitrogen adsorption surface area (NSA) in a range of from about 30 to about 60 m²/g together with a DBP adsorption value in a range of from about 70 to about 140 cc/100 g,
(B) about 5 to about 40 phr of carbon black comprised of at least one of:
(1) Category B low rubber reinforcing carbon black having a nitrogen adsorption surface area (NSA) in a range of from about 3 to about 30 m²/g together with a DBP adsorption value in a range of from about 20 to about 50 cc/100 g,
(2) Category C thermally conducting carbon black having a nitrogen adsorption surface area (NSA) in a range of from about 50 to about 75 m²/g, and
(3) Category D thermally conductive carbon black having a nitrogen adsorption surface area (NSA) in a range of from about 80 to about 120 m²/g together with a DBP adsorption value in a range of from about 190 to about 210 cc/100 g, and C. temperature activatable blowing agent.

3. The tire of claim 2 wherein said temperature activatable blowing agent is comprised of at least one of dinitrosopentamethylene tetramine, N,N′-dimethyl-N,N′-dinitrosophthalamide, azodicarbonamide, N,N′-dinitrosopentamethylene tetramine, sulfonyl hydrazides such as benzenesulfonyl hydrazide, toluene-sulfonyl hydrazide and p,p′-oxy-bis-(benzenesulfonyl)hydrazide and sulfonyl semicarbazides such as p-toluene sulfonyl semicarbazide, p,p′-oxy-bis-(benzenesulfonyl semicarbazide) and diphenyloxide-4,4′-disulphenyldrazide.

4. The tire of claim 2 wherein said temperature activatable blowing agent is comprised of diphenyloxide-4,4′-disulphenyldrazide.

5. A tire wherein said tire assembly of cured tire and uncured rubber composition of claim 2 is heated to activate said temperature activatable blowing agent to form a cellular rubber from said uncured rubber composition, and to cure said closed cellular rubber, to thereby form a pneumatic tire containing a cellular rubber within its tire cavity.

6. A wheel assembly is provided which is comprised of:
(A) a cylindrical metal tire rim, and
(B) the said tire of claim 1 fitted onto said rim with its internal cavity containing said closed cellular rubber wherein the rubber composition of said closed cellular rubber contains said dispersion of at least two diverse carbon blacks.

7. A wheel assembly comprised of
(A) a cylindrical metal tire rim, and
(B) the said tire of claim 2 fitted onto said rim with its internal cavity containing said plurality of layers of solid uncured rubber composition to form an assembly of said cured tire and uncured rubber composition, wherein said uncured rubber composition contains said dispersion of at least two of said diverse carbon blacks and a temperature activatable blowing agent.

8. The tire of claim 1 herein said diverse carbon blacks are comprised of said rubber reinforcing Category A carbon black and said low rubber reinforcing Category B carbon black.

9. The tire of claim 1 wherein said diverse carbon blacks are comprised of said rubber reinforcing Category A carbon black and said thermally conductive Category C carbon black.

10. The tire of claim 1 wherein said diverse carbon blacks are comprised of said rubber reinforcing Category A carbon black and said thermally conductivity Category D carbon black.

11. The tire of claim 2 wherein said diverse carbon blacks are comprised of said rubber reinforcing Category A carbon black and said low rubber reinforcing Category B carbon black.

12. The tire of claim 2 wherein said diverse carbon blacks are comprised of said rubber reinforcing Category A carbon black and said thermally conductive Category C carbon black.

13. The tire of claim 2 wherein said diverse carbon blacks are comprised of said rubber reinforcing Category A carbon black and said thermally conductive Category D carbon black.

14. The wheel assembly of claim 7 wherein said diverse carbon blacks are comprised of said rubber reinforcing Category A carbon black and said low rubber reinforcing Category B carbon black.

15. The wheel assembly of claim 7 wherein said diverse carbon blacks are comprised of said rubber reinforcing Category A carbon black and said thermally conductive Category C carbon black.

16. The wheel assembly of claim 7 wherein said diverse carbon blacks are comprised of said rubber reinforcing Category A carbon black and said thermally conductive Category D carbon black.

17. The tire of claim 1 wherein said closed cellular rubber is the product of temperature activation of a temperature activatable blowing agent.

18. The tire of claim 17 wherein said temperature activatable blowing agent is comprised of at least one of dinitrosopentamethylene tetramine, N,N′-dimethyl-N,N′-dinitrosophthalamide, azodicarbonamide, N,N′-dinitrosopentamethylene tetramine, sulfonyl hydrazides such as benzenesulfonyl hydrazide, toluene-sulfonyl hydrazide and p,p′-oxy-bis-(benzenesulfonyl)hydrazide and sulfonyl semicarbazides such as p-toluene sulfonyl semicarbazide, p,p′-oxy-bis-(benzenesulfonyl semicarbazide) and diphenyloxide-4,4′-disulphenyldrazide.

19. The tire of claim 17 wherein said temperature activatable blowing agent is comprised of diphenyloxide-4,4′-disulphenyldrazide.
